(19) United States
(12) Patent Application Publication
(10) Pub. No.: US 2022/0286864 A1
(43) Pub. Date: Sep. 8, 2022

(54) Shared Spectrum Access For Private Radio Networks

(71) Applicant: Doodle Labs (SG) PTE LTD, Somerset, NJ (US)

(72) Inventors: Nimesh D. Parikh, Mattawang, NJ (US); Simon Wunderlich, Thossfell (DE); Mario Jorge de Matos Lopes, Plauen (DE)

(73) Assignee: Doodle Labs (SG) PTE LTD, Somerset, NJ (US)

(21) Appl. No.: 17/630,277

(22) PCT Filed: Aug. 3, 2020
(86) PCT No.: PCT/US2020/044721

§ 371 Date: Jan. 26, 2022

Related U.S. Application Data
(60) Provisional application No. 62/882,767, filed on Aug. 5, 2019.

(51) Int. Cl. H04W 16/14; H04W 52/24; H04W 52/36; H04W 72/04

(52) U.S. Cl. CPC H04W 16/14; H04W 52/243; H04W 52/367; H04W 72/0453; H04W 88/16

(57) ABSTRACT

An apparatus for shared spectrum access (referred to at times hereinafter by the acronym “ASSA”, or more generally, as a “gateway device”) is configured to work with one or more private networks, providing control of operating parameters such as the assignment of a specific frequency band (channel), maximum level of transmission power at an assigned channel, and/or even the ability to use a shared spectrum assignments, updating as need be. By virtue of provisioning end-user devices (EUDs) with software-defined transceivers, the ASSA may function to broadcast “operation parameters” (i.e., assigned frequency band and maximum transmission power) to all EUDs within its range. The EUDs may be fixed or mobile devices.

### CROSS-REFERENCE TO RELATED APPLICATIONS

This application claims the benefit of U.S. Provisional Application No. 62/882,767, filed Aug. 5, 2019 and herein incorporated by reference.

### TECHNICAL FIELD

The present invention relates to the implementation of private radio networks and, more particularly, to an arrangement for utilizing shared spectrum techniques within a private radio network.

### BACKGROUND OF THE INVENTION

Responding to the ever-increasing need for wireless data communication, governments around the world are requiring certain low usage (but licensed) bands to be shared by multiple users. As an example, recently the Federal Communications Commission (FCC) released an order for commercial operations in the 3550-3700 MHz Band. The order creates a new Citizens Broadband Radio Service (CBRS) in this 3.5 GHz band. The order refers to this band as the “Innovation” band and promotes the development of new applications.

Spectrum sharing is defined as two or more communication systems that operate in the same band. Its attraction as a potential means of improving the overall spectrum usage efficiency has generated a strong interest as the increase of smart phones usage and fast growth of mobile broadband requirements by that and other usage creates a large need for finding new spectrum bands to serve the traffic. However, it is difficult to find new spectrum where there is sufficient availability and good frequency characteristics. At the same time, there are certain frequency bands that are reserved for government use (e.g., a particular governmental agency/military, etc.), where the actual use of the spectrum by the licensed agency is typically limited to specific geographic location or times of the day or combinations of the two usage criteria. In wide geographic areas and/or large parts of time, the spectrum can be empty of usage. Thus, “spectrum sharing” is a communications licensing method that allows current spectrum licensee to share their spectrum with users according to this regulatory framework (sharing framework) issued by a regulator. For the particular instance of spectrum sharing in the CBRS frequency band, the FCC is the regulatory authority that oversees the allocation of bandwidth, channel assignment, and power limits to users upon request.

Viewed from a somewhat more narrowed scope, the WiFi band itself spans a few hundred MHz that define hundreds of channels. Inasmuch as it is an unlicensed frequency band, there are always a large number of users. The relatively low power of operation limits the reach of a given band at a particular location. Without any control on channel assignments, there is no assurance that a given channel will remain free for an extended period of time. As a result, the WiFi option has not been attractive to the private radio market at this point in time, since “fixed frequency” radio equipment cannot accommodate constant changing/updating of the specific channel(s) used within the private network.

### SUMMARY OF THE INVENTION

The needs as outlined above are addressed by the present invention, which relates to the implementation of private radio networks and, more particularly, to an arrangement for utilizing shared spectrum techniques within a private radio network. In accordance with the principles of the present invention, an apparatus for shared spectrum access (referred to at times hereinafter by the acronym “ASSA”, or more generally, as a “gateway device”) is configured to work with one or more private networks, providing control of operating parameters such as the assignment of a specific frequency band (channel) and perhaps bandwidth, limitations on transmission power and duty cycle, and/or even the ability to use a shared spectrum assignments, updating as need be. By virtue of provisioning the end-user devices (EUDs) with software-defined transceivers (as described in detail in our co-pending applications PCT/US19/50134 filed Sep. 9, 2019 and PCT/US19/42339 filed Jul. 18, 2019), the ASSA may function to broadcast “operation parameters” (e.g., assigned frequency band, bandwidth, maximum transmission power, duty cycle, etc.) to all EUDs within its range. The EUDs may be fixed or mobile devices. In accordance with the principles of the present invention, the EUDs must remain “silent” (i.e., remain as passive devices) unless and until granted permission by a gateway device to operate at an assigned channel (with other associated operating parameters).

In one embodiment, the ASSA/gateway is configured to work with third-party entities that control channel assignment.

In another embodiment, multiple ASSAs/gateways are configured to work together and exchange information about specific channel assignments.

In either embodiment, environmental factors (such as interference from newly-arriving devices, other private networks, etc.) are taken into consideration and monitored on a regular basis by a separate element disposed within the network to supplement the information used in the channel assignment decision-making process.

An exemplary embodiment of the present invention takes the form of a gateway device for use in a shared spectrum environment to provide communication with a plurality of end-user devices in a private wireless communication network via an assigned frequency band. In particular, the gateway device comprises a communication module, a transceiver and an antenna module. The communication module functions to receive operating parameters from a third-party entity authorized to regulate spectrum sharing among a plurality of users, the operating parameters including at least a definition of the assigned frequency band. The transceiver utilizes software-defined controls to tune transmission and reception to the assigned frequency band, where the antenna module is used to support communication between the gateway device and a plurality of end-user devices (also software-controlled to operate at the assigned frequency band and using the same operating parameters) within a private radio network.

Other and further aspects and features of the present invention will become apparent during the coursing of the following discussion and by reference to the accompanying drawings.

### BRIEF DESCRIPTION OF THE DRAWINGS

Referring now to the drawings, where like numerals represent like parts in several views:

FIG. 1 illustrates a general architecture for providing spectrum sharing within private networks supported by specialized gateway devices formed in accordance with the present invention;

FIG. 2 contains a diagram of signal flows between a third-party access system associated with the shared spectrum, the specialized gateway device, and an end-user device (EUD);

FIG. 3 is a diagram of an exemplary specialized transceiver used by the gateway device and the group of EUDs;

FIG. 4 illustrates an alternative embodiment of the present invention, in this case where three separate private radio networks all operate on different channels within the shared spectrum, controlled by the third-party access system;

FIG. 5 is a diagram of an alternative specialized transceiver, further configured to receive communications via an external RF modem;

FIG. 6 illustrates yet another embodiment of the present invention, using the alternative specialized transceiver as shown in FIG. 5; and

FIG. 7 shows a different embodiment of the present invention, where a plurality of gateway devices are particularly configured to perform spectrum sharing among themselves, “self-selecting” channel assignments and monitoring operating parameters of the group of gateway devices.

### DETAILED DESCRIPTION

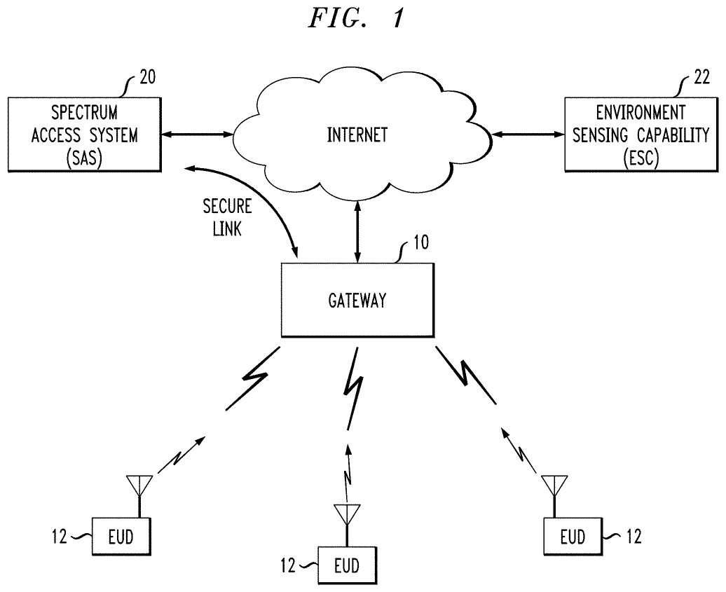

FIG. 1 illustrates an example of a general architecture for an exemplary shared spectrum access system suitable for use with private radio equipment in accordance with the principles of the present invention. The particular configuration as shown in FIG. 1 is based upon the utilization of spectrum sharing within the Citizen Broadband Radio Service (CBRS) band, as described above. In particular, the configuration as shown in FIG. 1 is based upon the use of a private radio gateway device 10 that communicates with a third-party controlled spectrum access system 20 (that is, an identified third party given the authority by the FCC for controlling spectrum sharing in the CBRS frequency band) to request a specific channel from that band that may be used by gateway 10 to communication with a plurality of end-user devices (EUDs) 12. These EUDs 12 may be “fixed” devices, or mobile devices. For example, in industrial implements, the EUDs may comprise sensors on equipment (drilling rigs, downhole sensors), surveying equipment, and the like. Collectively, gateway 10 and EUDs 12 comprise a given private network. As will be explained in detail below, by virtue of the unique frequency-shifting capabilities of gateway 10 and EUDs 12 formed in accordance with the present invention, the private network is able to make use of shared spectrum access in a relatively straightforward manner, without the need to incorporate additional equipment, and is able to operate at virtually any assigned frequency channel (and also change channel assignment as the need arises). As mentioned above, EUDs 12 are considered as passive devices that may only function in a listening mode of scanning for a beacon from gateway device 10; only after receiving permission to communication on an assigned channel may EUDs 12 become active devices that transmit and receive communications from others.

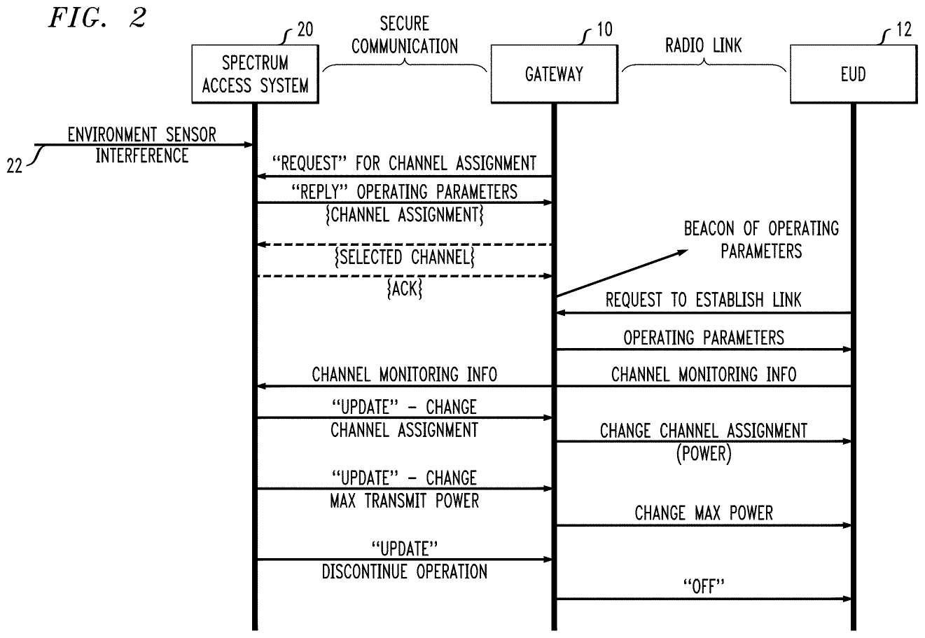

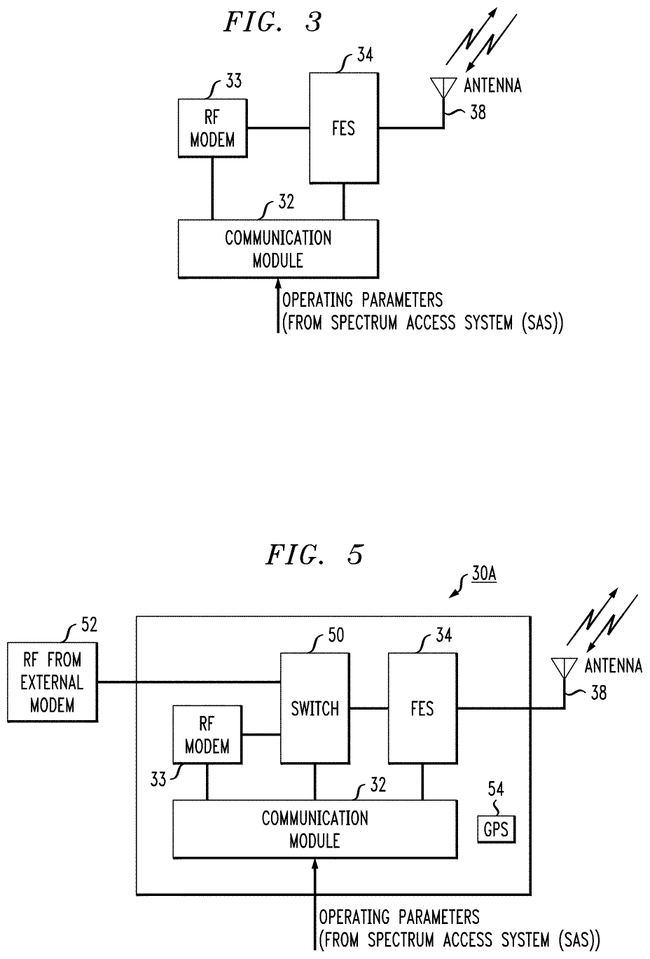

FIG. 2 contains a diagram of the signal flows between spectrum access system 20, gateway 10, and EUDs 12 that is useful to review during the following detailed discussion of FIG. 1. The specific “frequency shifting” capability of gateway 10 and EUDs 12 will follow in association with FIG. 3. For the purposes of understanding the overall application of shared spectrum techniques in the arrangement of FIG. 1, this frequency-shifting capability will be presumed.

Now referring to both FIGS. 1 and 2, spectrum sharing is first initiated by gateway 10 transmitting “request for channel assignment” to spectrum access system 20. As shown, the transmissions between gateway 10 and spectrum access system 20 need to be sent over a secure link, utilizing encryption. This initial request includes various operating parameters associated with gateway 10 (including its geographic location, broadcasting capabilities (antenna gain, bandwidth, etc.)).

Spectrum access system 20 uses this provided information to determine an appropriate frequency band (channel) for use by gateway 10 to communicate with the EUDs within its private network. Also shown in FIG. 1 is an environment monitoring system 22 that may also communicate with spectrum access system 20 and provide additional information (for example, regarding sources of interference) in the geographic location of gateway 10, and the like.

With all of this input, spectrum access system 20 then selects a specific channel (or perhaps a range of available frequencies) and transmits a secure (encrypted) reply message to gateway 10 (see FIG. 2) including this information. The reply message, referred to as a “channel assignment message” typically includes additional operating parameters besides the assigned channel, such as the maximum power level at which gateway 10 (and associated EUDs 12 within its private network) may operate, the bandwidth of the assigned channel, duty cycle limitations, and the like. For the case where spectrum access system 20 sends a channel assignment message including a range of available frequencies, gateway 10 functions to select a particular frequency channel, and then transmit a message back to system 20 reporting its selection (shown by the dotted line in FIG. 2).

Once gateway 10 has received a channel assignment message from spectrum access system 20, it thereafter transmits a beacon broadcasting its ability to provide communication. Any EUDs 12 within its transmission range may then respond, with both the beacon and response shown in FIG. 2. Gateway 10 thereafter sends the “assigned channel” operating parameters to EUDs 12 and the private network is established, with gateway 10 and EUDs 12 using their unique frequency-shifting capabilities described below and elsewhere to automatically “tune” to the assigned channel. Upon establishing the communication link between each EUD 12 and gateway 10, the EUD 12 is authorized to communicate over only the assigned channel, and must agree comply with all of the other operating parameters included in the authorization.

As mentioned above, the utilization of spectrum sharing requires gateway 10 (and EUDs 12) to be flexible and adapt to changing the assigned channel upon receiving a command to do so from spectrum access system 20. For example, an “incumbent” may request the use of the specific channel that had been assigned to gateway 10. When that occurs, spectrum access system 20 sends an “updated channel assignment” message to gateway 10 (as shown in FIG. 2). Gateway 10 acknowledges this request, and passes on the updated channel assignment (and associated power level limitation) to all communication EUDs 12. In other cases, spectrum access system 20 may transmit a “change transmission power level” to gateway 10. Here, the channel assignment stays the same, but the EUDs will likely need to reduce the power level at which they are operating. In some cases, spectrum access system 20 may transmit a “discontinue operation” command to gateway 10, requiring all communications to be immediately shut down by a command to completely disconnect from the shared spectrum system. Upon receiving any of these updates, gateway 10 must immediately pass the information along to all communicating EUDs 12 so they can update accordingly.

It is contemplated that in an alternative embodiment, gateway 10 may communicate via an established base station, such as a Citizen's Broadband radio Service Device (CBSD), taking on the role of an EUD and performing a frequency scan to search for beacons transmitted by a CBSD. In this embodiment, gateway 10 thus “listens” for a CBSD beacon (and otherwise performs no transmission). Once communication is established between gateway 10 and a CBSD, a set of operating parameters are sent to gateway 10, which then ‘converts’ into operation as a base station for its associated private network with EUDs 12, re-broadcasting the assigned parameters as its own beacon and thereafter setting up communication with EUDs 12 that respond. While idle, gateway 10 may perform spectrum scanning for environmental factors (such as, for example, interference from neighboring networks). Gateway devices of this type that may function as either an EUD or a base station may be referred to at times as a “hybrid gateway”.

In various embodiments, it is to be understood that either one or both of gateway 10 and EUDs 12 may also include a “second radio”, configured to operate at a different (fixed) frequency, such as using a WiFi communication link. Indeed, this “second radio” may be used in various embodiments as a separate communication channel to exchange information on channel assignments, environmental (interference) information, create ad hoc mesh networks (for private radio communications on the assigned channel), and the like.

As mentioned above, a significant aspect of the ability of private networks formed by gateway 10 and EUDs 12 to operate in a “shared spectrum” environment is their ability to perform “frequency shifting”, with the ability to adjust (tune) the channel at which they communicate in real time. FIG. 3 is a block diagram of an exemplary specialized transceiver 30, included within both gateway 10 and EUDs 12, that is specifically formed to provide frequency shifting from baseband transmissions into a specific frequency band (here, the assigned channel within the CBRS spectrum). As described in detail in our co-pending applications (cited above) frequency shifting into other bands may be provided by using an external heterodyne mixer to shift a standard frequency into another (software-defined) band, which in this case is the “assigned channel” from the shared spectrum.

In the arrangement as shown in FIG. 3, a communication module 32 is shown as receptive to the incoming channel assignment information (when specialized transceiver 30 is included in gateway 10, the information is from spectrum access system 20; when specialized transceiver 30 is included in EUD 12, the information is from gateway 10). The communication signals supplied to communication module 32 are passed to an RF modem 33 (referred to at times as an “internal modem”), and then supplied as an input to a front-end system 34. As shown, the specific channel assignment information is also provided as an input to front-end system (FES) 34. As discussed in detail in our co-pending applications, FES 34 includes the specific, tunable transmitter and receiver components used to configure operation of gateway 10 and EUDs 12 at the assigned frequency and power level.

That is, when applied as an input thereafter to FES 34, the RF data signals are frequency-shifted into the assigned channel and are thereafter transmitted (either from gateway 10 to EUD 12, or from EUD 12 to gateway 10) via antenna system 38. In the receive mode, an incoming wireless signal operating on the assigned channel is first frequency-shifted by FES 34 back into a conventional RF frequency band, where this RF signal is then delivered to RF modem 33. Detailed descriptions of the frequency-shifting capabilities of gateway 10 and EUDs 12 can be found in our co-pending applications referenced above.

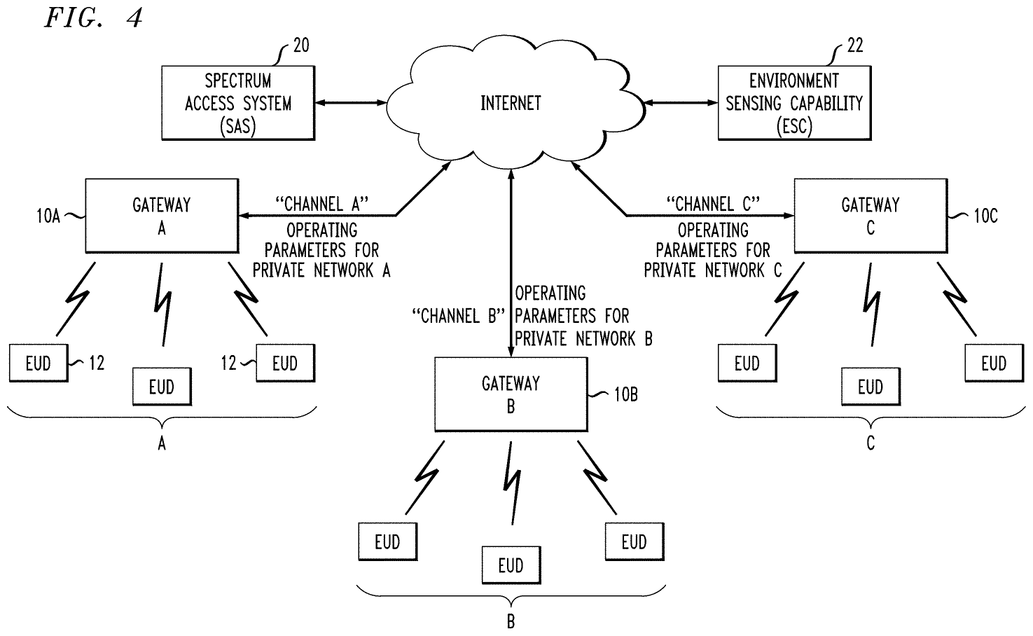

While the configuration of FIG. 1 illustrates only a single gateway device 10 in communication with spectrum access system 20, it is to be understood that in actual practice a large number of separate and independent gateways may all interact with spectrum access system 20, with system 20 functioning to assign a different channel within the shared spectrum to each gateway. FIG. 4 illustrates an exemplary network architecture formed in accordance with the present invention, where a set of three separate private networks (labelled “A”, “B”, and “C”) all communicate with spectrum access system 20. In particular, separate gateway devices 10A, 10B, and 10C all communicate over secure (encrypted) transmission paths with system 20. For this example, the individual private radio networks are independently operated and do not communicate with each other.

Using the same process as described above, spectrum access system 20 functions to assign a specific channel to each private network (shown as “Channel A”, “Channel B”, and “Channel C” in FIG. 4). Similar changes/updates in assigned channels and power levels are communicated between spectrum access system 20 and each individual gateway 10A, 10B, and 10C.

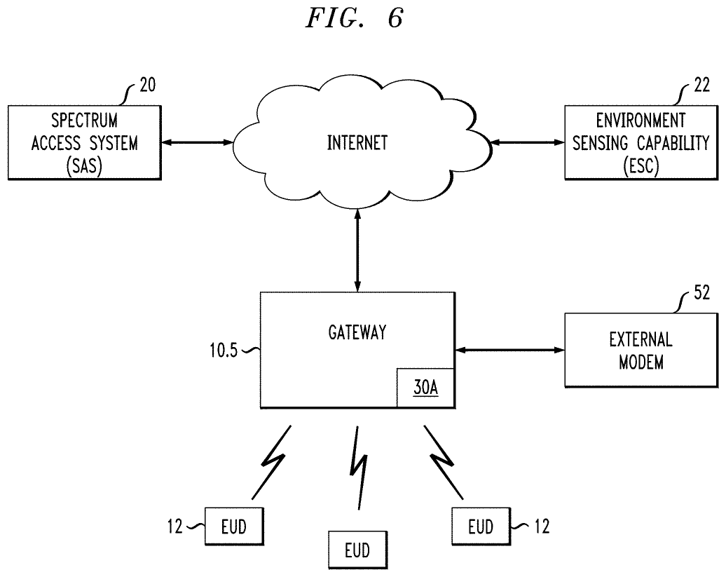

FIG. 5 is a diagram of an alternative embodiment of a specialized frequency-shifting transceiver 30A that may be used by gateway 10 (instead of transceiver 30 as shown in FIG. 3) as a means of providing communication over the assigned channel with other devices that are not equipped to operate in the CBRS bands (for example, signals from an LTE modem, WiFi router, etc.), but are located within the communication range of gateway 10. In particular, specialized transceiver 30A is shown as including an RF switch 50 that is disposed at the input to FES 34. RF switch 50 includes two separate inputs, one being the “internal” RF modem 33 as discussed above. The remaining input is from an “external” RF modem 52, which may be associated with any conventional network-enabled device within the range of gateway 10. In this case, therefore, when RF switch 50 is set to receive communications from external network-enabled devices, these communications (on the conventional RF frequencies) are similarly passed through FES 34 to be shifted into the assigned channel. “Received” communications on the assigned channel that are destined for these external devices follow the same incoming path through FES 34, where RF switch 50 ensures that the received signal is directed to the external device. Also shown in the embodiment of FIG. 5 is a GPS unit 54 which may be used to indicate the current location of gateway 10.

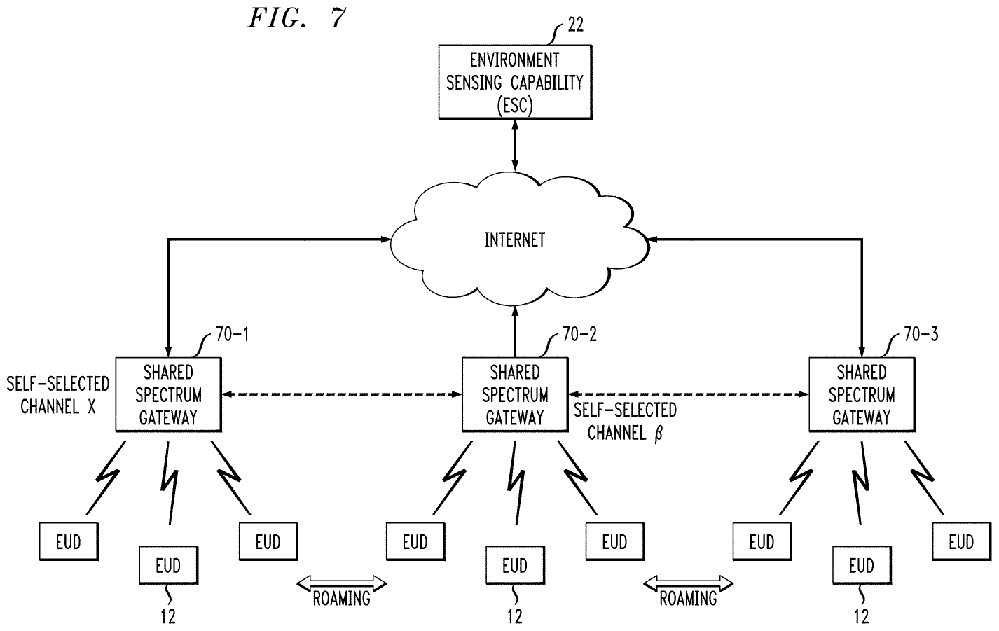

FIG. 6 is an alternative embodiment of the arrangement of FIG. 1, where an exemplary gateway 10.5 includes specialized transceiver 30A as discussed above, providing an additional set of communication paths with conventional devices via external modem 34. While certain communication devices 40 (such as mobile phones, laptops, etc.) do not include any specialized frequency-shifting components and cannot communicate on an assigned CBRS band, gateway 10.5 can function as an interface between these devices 40 and the backbone network. In particular, gateway 10A continues to operating using the assigned channel from spectrum access system 20, but in this case frequency-shifts the assigned channel to the RF frequency conventionally used with devices communicating via external modem 34. Upstream transmissions from these devices are received by gateway 10.5, which then converts the transmission to the assigned channel. Thus, gateway 1.50 enables any conventional RF modem (narrowband, wideband, 3G, 4G, and the like) to operate in a shared spectrum band (such as the CBRS band).

Beyond the embodiments described above where gateway 10 is configured to communicate with a third-party authority appointed to oversee spectrum sharing, it is contemplated that the advantages of spectrum sharing may be performed on a more “local” level, with a group of similarly-configured gateway devices collaborating in a way that they “self-assign” certain channels within a specific frequency band. For example, the techniques of the present invention as outlined above may be used by a set of individual private networks (each having its own gateway device) to select specific operating channels in a way that interference between the networks is minimized.

An example of collaborative spectrum sharing is shown in FIG. 7, where a set of spectrum-sharing gateway devices 70-1, 70-2, and 70-2 all operate in the WiFi band (5.8 GHz). This band is a few-hundred MHz wide, with many different channels to choose from in the band. The WiFi band is unlicensed globally, so there are almost an unlimited number of users of the frequencies in the band. When the separate private networks shown in FIG. 7 all operate in the WiFi domain, interference among them depends on several factors (channel spacing, power level, etc.). Spectrum-sharing gateway devices 70-1, 70-2, and 70-3 may communicate with one other via the internet (as shown), or they may establish direct connections between each other (these direct connections being either wireline connections or wireless connections). Indeed, spectrum-sharing gateway devices 70 may use a mesh networking capability to establish self-configuring connections, where the mesh topology is considered to simplify the deployment of the inventive system.

For example, spectrum-sharing gateway devices 70 may be configured to collaborate with each other, collect spectrum usage information (sharing this information with the other spectrum-sharing gateway devices) and develop a frequency map based on this information. Spectrum usage information may contain, for example, duty cycle and signal strength, signal strength of neighboring gateways, signal strength of “rogue” (i.e., non-networked) gateways, and the like. For example, channels may be assigned to spectrum-sharing gateway devices 70 using a distributed algorithm, or one of the gateways can be elected as a “master” to compute the channel mapping, or an external device/server may be used to perform the channel assignments among the several spectrum-sharing gateway devices 70.

Referring in particular to FIG. 7, spectrum-sharing gateway device 70-1 may be the first deployed in a certain geographic area will begin to operating on a first channel X (for example). When spectrum-sharing gateway device 70-2 is next deployed, it will establish communication with spectrum-sharing gateway device 70-1, and “self-assign” a channel within the shared WiFi spectrum that is sufficiently removed from the channel being used by spectrum-sharing gateway device 70-1 (for example, “Channel β”). In a preferred embodiment, spectrum-sharing gateway devices 70 are configured to perform spectrum scanning to determine available frequencies for use (as well as identify potential sources of interference). The process continues in a similar manner, with each newly-arriving spectrum-sharing gateway device functioning to “discover” all of the local spectrum-sharing gateway devices and their operating channels, and use this information to select a different channel for operation. This collaboration between spectrum-sharing gateway devices is contemplated to be an on-going effort, with the ability to modify power levels and change channel assignments continuing over time. During the remainder of the time that the individual private networks are operating, spectrum-sharing gateway devices 70-1, 70-2, and 70-3 continue in a collaborative manner to send networking monitoring updates to each other, such as “received signal strength” in the assigned channel (as well as adjacent frequencies), received packet error rates, and the like.

Moreover, when utilized in conjunction with mobile EUDs 72, it is contemplated that similar to the “hand-off” in cellular communication, an individual EUD 72a moving from first spectrum-sharing gateway 70-1 to spectrum-sharing second gateway 70-2 will receive a change in channel assignment as soon as that specific EUD receives a stronger signal from spectrum-sharing gateway 70-2 than from spectrum-sharing gateway 70-1.

Inasmuch as spectrum-sharing gateway devices 70 (and their associated EUDs 72) are all configured to include frequency-shifting capabilities in the manner described above and in our co-pending applications, the sharing of any spectrum (such as WiFi) is contemplated to provide improved performance in terms of signal clarity, minimal interference, and the like.

What is claimed is:

1. A gateway device for use in a shared spectrum environment to provide communication with a plurality of end-user devices in a private wireless communication network via an assigned frequency band, the gateway device comprising
a communication module for receiving operating parameters from a third-party entity authorized to regulate spectrum sharing among a plurality of users, the operating parameters including at least a definition of the assigned frequency band;
a transceiver including an internal modem, the transceiver utilizing software-defined controls to tune transmission and reception to the assigned frequency band; and
an antenna module for broadcasting a communication beam to the plurality of end-user devices and, in response to an acknowledgement from an end-user device transmitting the operating parameters received from the third-party entity.

2. The gateway device as defined in claim 1 where the received operating parameters also include one or more elements selected from a group consisting of: a maximum transmission power level permitted by the third-party entity, a defined bandwidth for the assigned frequency band, and a defined duty cycle for transmissions between the gateway device and the plurality of end-user devices.

3. The gateway device as defined in claim 1 wherein the communication module is configured to continuously monitor communications from the third-party entity for reception of updated operating parameters.

4. The gateway device as defined in claim 3 wherein an updated operating parameter includes a change in assigned frequency band, the gateway device thereafter transmitting the change in assigned frequency band to the plurality of end-user devices.

5. The gateway device as defined in claim 3 wherein an updated operating parameter includes a change in allowable transmission power level, the gateway device thereafter transmitting the change in allowable transmission power level to the plurality of end-user devices.

6. The gateway device as defined in claim 3 wherein an updated operating parameter includes a command to discontinue transmission on the shared spectrum.

7. The gateway device as defined in claim 1 wherein the shared spectrum is the Citizen Band Radio Service (CBRS) frequency band.

8. The gateway device as defined in claim 1 wherein the assigned operating parameters are further based upon environment information, including interference from neighboring communication devices, used by the third-party entity in the process of selecting an assigned frequency band.

9. The gateway device as defined in claim 1 wherein the communication module is configured to communicate with the third-party entity over a secure communication link.

10. The gateway device as defined in claim 1 wherein the gateway device further comprises an RF switch to select between operating with the internal modem and RF signals arriving from an external modem.

11. The gateway device as defined in claim 1 wherein the gateway device further comprises a GPS component, utilized to transmit location data to the third-party entity.

12. An end-user device including communication and computing capabilities for being controlled within a wireless communication network by a gateway device, the end-user device comprising
an antenna module for receiving transmissions from the gateway device, the transmissions including at least operating parameters associated with spectrum sharing;
a processor for performing frequency scanning and responding to a beacon transmission from the gateway device, the processor thereafter responsive to the operating parameter transmissions for determining an assigned frequency band for communicating with the gateway device; and
a transceiver utilizing a software-defined communication frequency band to operate at the assigned frequency band defined by the gateway device.

13. A system for providing spectrum sharing among a plurality of separate private networks, the system comprising
a plurality of spectrum-sharing gateway devices, each spectrum-sharing gateway device configured to self-select an available frequency band from within a defined spectrum designated for sharing among different users, with each spectrum-sharing gateway device including:
a communication module for communicating with other spectrum-sharing gateway devices to exchange information regarding self-selected transmission frequency bands;
a transceiver including an internal modem, the transceiver utilizing software-defined controls to tune transmission and reception to the self-selected frequency band; and
an antenna module for broadcasting a communication beam to the plurality of end-user devices and, in response to an acknowledgement from an end-user device transmitting the self-selected frequency band for supporting communications between the end-user device and the spectrum-sharing gateway device.

14. The system as defined in claim 13 wherein the process of self-selecting a frequency band is further based upon environment information received by the plurality of spectrum-sharing gateway devices, the environment information including interference from neighboring communication devices.

15. The system as defined in claim 13 wherein communication between the plurality of spectrum-sharing gateway devices is provided, at least in part, through the internet.

16. The system as defined in claim 13 wherein communication between the plurality of spectrum-sharing gateway devices is provided, at least in part, through direct communication links established between the communication modules of the individual spectrum-sharing gateway devices.

17. The system as defined in claim 16 wherein the plurality of spectrum-sharing gateway devices are configured as a mesh network.

18. The system as defined in claim 13 wherein each spectrum-sharing gateway device is configured to perform spectrum scanning for use in self-selecting a frequency channel.

19. The system as defined in claim 13 wherein the plurality of spectrum-sharing gateway devices are configured to operate over the WiFi frequency band.

20. A hybrid gateway device for use in a shared spectrum environment to provide communication with a plurality of end-user devices in a private wireless communication network via an assigned frequency band, the hybrid gateway device comprising
a frequency scanning module for discovering a beacon broadcast by a CBRS device (CBSD);
a communication module for responding to the CBSD and receiving therefrom a set of operating parameters including at least a definition of the assigned frequency band;
a transceiver including an internal modem, the transceiver utilizing software-defined controls to tune transmission and reception to the assigned frequency band; and
an antenna module for broadcasting a communication beam to the plurality of end-user devices and, in response to an acknowledgement from an end-user device transmitting the operating parameters received from the third-party entity, wherein the hybrid gateway device provides the functionality of an EUD with respect to the CBSD and a gateway device with respect to the plurality of communication EUDs.

21. The hybrid gateway device as defined in claim 20 wherein the communication module is further configured to receive operating parameters from a third-party entity authorized to regulate spectrum sharing among a plurality of users, the operating parameters including at least a definition of the assigned frequency band.

22. The hybrid gateway device as defined in claim 20 wherein the communication module is further configured to communicate with other hybrid gateway devices to exchange information regarding self-selected transmission frequency bands.

23. The hybrid gateway device as defined in claim 20 wherein the communication module is configured to establish direct communication links with the communication modules of other hybrid gateway devices.

24. The hybrid gateway device as defined in claim 23 wherein a plurality of hybrid gateway devices are configured as a mesh network.
